(19) United States
(12) Patent Application Publication
(10) Pub. No.: US 2010/0315345 A1
(43) Pub. Date: Dec. 16, 2010

(54) Tactile Touch Screen

(75) Inventor: Pauli Laitinen, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/443,345

(22) PCT Filed: Sep. 27, 2006
(86) PCT No.: PCT/EP2006/009377

§ 371 Date: Apr. 22, 2010

(51) Int. Cl. G06F 3/041

(52) U.S. Cl. 345/173

(57) ABSTRACT

A touchscreen including a touch sensitive layer wherein the user perceived surface roughness or friction coefficient is variable and dynamically controlled. The level of user perceived surface roughness or friction coefficient is related to the information that is displayed at the position at which an object touches the touch sensitive layer. The surface roughness is not locally changed but rather for a complete portion of the touchscreen or for the whole touchscreen simultaneously. Because the modulation of user experience surface roughness or friction coefficient is faster than the user interaction, the user will experience that the surface roughness of certain areas of the display is different from other areas, depending on the information that is being shown, although in fact the surface roughness or friction coefficient is uniform over the whole portion or the whole display at any given point of time.

### FIELD OF THE INVENTION

The present invention relates to touch screens. Further, the invention relates to a method of operating a touch screen and to a software product carrying out with you the method when run on a processor.

### BACKGROUND OF THE INVENTION

Touchscreens are widely used in a variety of mobile electronic devices, such as PDAs and mobile phones. Touchscreens offer an increased flexibility when compared to the more conventional combination of keypad and conventional LCD display, and a touchscreen offers a graphical user interface that can be operated in a manner similar to the graphical user interface for desktop computers with the mouse or other pointing device of the desktop computer being replaced by a stylus or the user's finger to point at a particular item or object of the graphical user interface.

A drawback of touchscreens is that they do not offer much tactile feedback to the user. Attempts have been made to alleviate this problem by providing transparent overlays that have a different texture, surface roughness or friction coefficient in particular areas that match the position of certain objects of a graphical user interface in a particular application. These transparent overlays to improve tactile-feedback, however, at the cost of practically losing all of the flexibility of the touchscreen.

Thus, there is a need for a touchscreen that provides tactile feedback while maintaining the flexibility associated with conventional touchscreens.

### DISCLOSURE OF THE INVENTION

On this background, it is an object of the present invention to provide a touchscreen that at least partially fulfills the above need. This object is achieved by providing a touch sensitive screen display comprising a touch sensitive screen surface, at least a portion of the touch sensitive screen surface having a variable and controllable user perceived surface roughness or friction coefficient.

By varying the user perceived surface roughness or friction coefficient in a controllable manner, the user receives while moving an object over the surface tactile feedback in the form of increased or lowered friction or surface roughness that will assist the user in navigating over the touchscreen and in identifying areas of a particular interest. Thus, user confidence and ease of use will be improved and thereby the acceptance of touchscreen technology will increase.

Preferably, user perceived surface roughness or friction coefficient is dynamically variable.

The user perceived surface roughness or friction coefficient can be dynamically varied whilst an object is moving over the touch sensitive screen surface.

Preferably, the user perceived surface roughness or friction coefficient is uniform for the whole of the portion of the touch sensitive screen.

The speed of change of the perceived friction coefficient or roughness is faster than the user interaction, so that a friction or roughness pattern can be created in tact with the user interaction.

Preferably, information is displayed on the touch sensitive screen display in the portion having a variable and controllable user perceived surface roughness or friction coefficient, and in this case the user perceived surface roughness or friction coefficient of the portion is controlled in dependence on the information displayed at the position at which an object touches the touch screen.

The information can be displayed as information items on a background, in which case the level of perceived surface roughness or friction coefficient associated with the background is different from the level or levels of perceived surface roughness or friction coefficient associated with the information items.

The level of perceived surface roughness or friction coefficient associated with an information item may be applied when an object touches the touch sensitive screen display in an area of the touch sensitive surface that substantially corresponds to the outline of the displayed information item.

The portion of the touch sensitive screen surface can be provided with plurality of controllable protuberances and/or indentations.

Preferably, the protuberances are simultaneously controlled between a substantially flat position and an extended position. The indentations may be simultaneously controlled between a retracted position and a substantially flat position.

The user perceived roughness or friction coefficient of the portion can be controlled by varying the position of the protuberances and/or the indentations.

The protuberances may be simultaneously controlled between a plurality of intermediate positions in between the substantially flat position and the extended position.

The indentations may be simultaneously controlled between a plurality of intermediate positions in between the substantially flat position and the retracted position.

The protuberances and/or the indentations can be part of fluid filled compartments disposed in the touch sensitive screen display.

The filled compartments are preferably operably connected to a controllable source of pressure.

The compartments can be covered by an elastic sheet.

The protuberances can be formed by the elastic sheet bulging out under high pressure of the fluid in the compartments.

The indentations can be formed by the elastic sheet bulging in under the pressure difference between the atmosphere and low pressure of the fluid in the compartments.

The pressure in the compartments can be controlled by a voltage driven actuator. The voltage driven actuator can be a piezo-actuator.

The protrusions can be elongated elements that extend in parallel across the portion of the touchscreen.

It is another object of the present invention to provide a method of operating a touchscreen of an electronic device, the touchscreen being provided with touch sensitive surface and at least a portion of the touch sensitive surface in a having a dynamically controllable variable user perceived roughness or friction coefficient, comprising displaying information on the touchscreen, and dynamically controlling the user perceived surface roughness or friction coefficient of the whole of the portion in relation to the information displayed at the position where an object touches the touch sensitive surface.

Preferably, the method further include displaying the information as information items on a background, and associating a first value of the user perceived roughness or friction coefficient to the background and associating one or more other values of the user perceived roughness or friction coefficient to the information items.

The method may further include changing the value of the user perceived roughness or friction coefficient to the level associated with an information item when an object touches the touchscreen at a position at which the information item concerned is displayed, and changing the value of the user perceived roughness or friction coefficient to the level associated with the background when an object touches the touchscreen at a position at which only the background is displayed.

The method may also include associating a first level of user perceived roughness or friction coefficient to an information item when it is not highlighted and a second level of user perceived roughness or friction coefficient different from the first level to an information item when the item concerned is highlighted.

Preferably, the level of user perceived roughness or friction coefficient is changed faster than the user interaction.

It is yet another object of the invention to provide a software product for executing the method.

Further objects, features, advantages and properties of the touchscreen, the method and the software product according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a front view of a mobile electronic device according to a preferred embodiment of the invention which includes a touchscreen according to an embodiment of the present invention and a screenshot that illustrates an exemplary way of operating the touchscreen,

FIG. 2 is a block diagram illustrating the general architecture of the mobile electronic device illustrated in FIG. 1,

FIG. 3 includes three side views of the touchscreen according to an embodiment of the invention illustrating the operation of the surface roughness/friction coefficient control,

FIG. 4 is a diagrammatic sectional view illustrating the construction of the touchscreen according to an embodiment of the invention,

FIG. 5 is a cross-sectional view of the touchscreen shown in FIG. 4,

FIGS. 6a-6d shows four screenshots illustrating an exemplary way of operating the touchscreen according to an embodiment of the invention,

FIG. 7 shows a screenshot illustrating another way of operating the touchscreen according to the invention, and

FIG. 8 is a flowchart illustrating the operation of an embodiment of the invention.

### DETAILED DESCRIPTION OF PREFERRED EMBODIMENTS

In the following detailed description, the touchscreen, the electronic device, the method and the software product according to the invention in the form of a personal computer, PDA, mobile terminal or a mobile communication terminal in the form of a cellular/mobile phone will be described by the preferred embodiments.

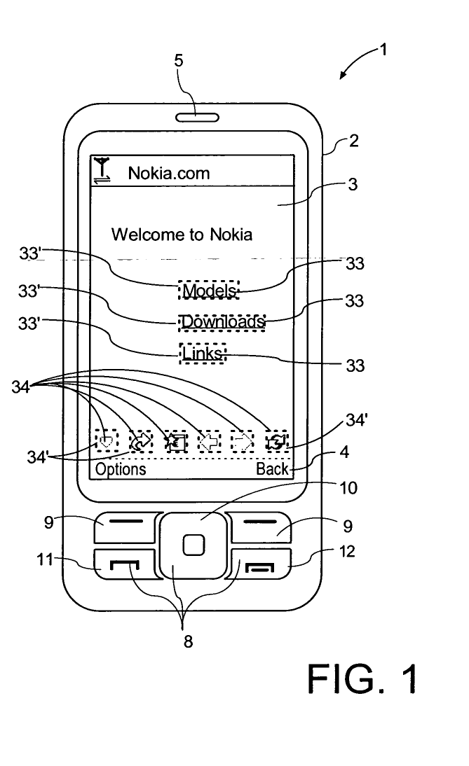

FIG. 1 illustrates a first embodiment of a mobile terminal according to the invention in the form of a mobile phone by a front view. The mobile phone 1 comprises a user interface having a housing 2, a touchscreen 3, an on/off button (not shown), a speaker 5 (only the opening is shown), and a microphone 6 (not visible in FIG. 1). The mobile phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

Virtual keypads with alpha keys or numeric keys, by means of which the user can enter a telephone number, write a text message (SMS), write a name (associated with the phone number), etc. are shown on the touchscreen 3 (these virtual keypad are not illustrated in the Figs.) when such input is required by an active application. A stylus or the users fingertip are used making virtual keystrokes.

The keypad 7 has a group of keys comprising two softkeys 9, two call handling keys (offhook key 11 and onhook key 12), and a 5-way navigation key 10 (up, down, left, right and center: select/activate). The function of the softkeys 9 depends on the state of the phone, and navigation in the menu is performed by using the navigation-key 10. The present function of the softkeys 9 is shown in separate fields (soft labels) in a dedicated area 4 of the display 3, just above the softkeys 9. The two call handling keys 11,12 are used for establishing a call or a conference call, terminating a call or rejecting an incoming call.

The navigation key 10 is a four- or five-way key which can be used for cursor movement, scrolling and selecting (five-way key) and is placed centrally on the front surface of the phone between the display 3 and the group of alphanumeric keys 7.

A releasable rear cover (not shown) gives access to the SIM card (not shown), and the battery pack (not shown) in the back of the phone that supplies electrical power for the electronic components of the mobile phone 1.

The mobile phone 1 has a flat display screen 3 that is typically made of an LCD screen with back lighting, such as a TFT matrix capable of displaying color images. A touch sensitive layer, such as a touch sensitive layer based on a capacitive sensing principle is laid over the LCD screen.

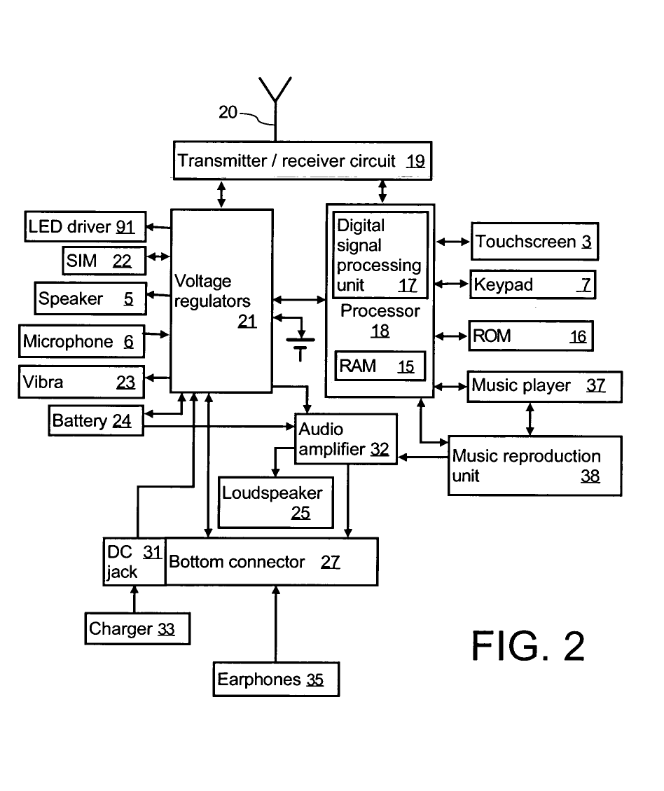

FIG. 2 illustrates in block diagram form the general architecture of the mobile phone 1 constructed in accordance with the present invention. The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 91 (for the LEDS backlighting the keypad 7 and the display 3), the SIM card 22, battery 24, the bottom connector 27, the DC jack 31 (for connecting to the charger 33) and the audio amplifier 32 that drives the (hands-free) loudspeaker 25.

The processor 18 also forms the interface for some of the peripheral units of the device, including a (Flash) ROM memory 16, the touch sensitive display screen 3, and the keypad 7.

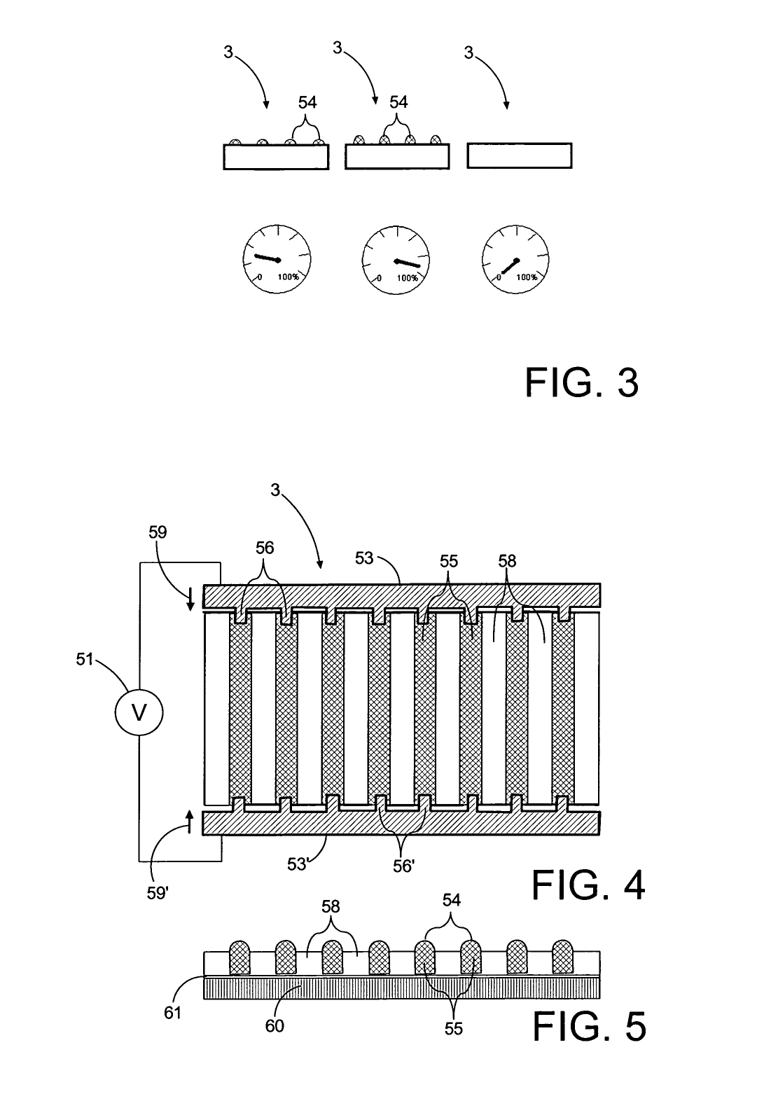

FIG. 3 illustrates in a diagrammatic manner the operation of the variable user perceived surface roughness or friction coefficient of the touch sensitive surface of the touchscreen 3 by three side views. The top surface of the touchscreen 3 is provided with a plurality of closely spaced controllable protuberances 54. The protuberances are in the shown embodiment elongated elements that extend in parallel across the surface of the touchscreen 3. According to other embodiments (not shown) the protuberances can have a circular or elliptic outline, and can be arranged in a grid array.

The protuberances 54 are voltage controlled, with a low or zero voltage resulting in the protuberances 54 being substantially flush with the top surface of the touchscreen 3. With increasing voltage applied to the actuating system (the actuating system will be explained in greater detail further below) the protuberances 54 raise from the surface with an increasing extent. The middle view in FIG. 3 illustrates the situation when a high voltage is applied to the actuating system and the protuberances 54 bulge out from the top surface of the touchscreen 3 to their maximum extent. The left of the views in FIG. 3 illustrates the situation when a medium voltage is applied to the actuating system and the protuberances 54 bulge out to an intermediate extent. The right side view in FIG. 3 illustrates the situation when a zero voltage is applied to the actuating system and the protuberances 58 are substantially flush with the top surface of the touchscreen 3.

FIGS. 4 and 5 illustrate the actuating system for the dynamically controlled protuberances 54. The actuating system includes a variable voltage source 51 that is controlled by the processor 18, or by another processor (not shown) that belongs to the touchscreen 3. This other processor will be coupled to the processor 18. The actuating system further includes two piezoelectric actuation members 53 and 53′ that are arranged at opposite sides of the display 3. The actuation members 53 and 53′ are provided with a plurality of plungers 56 and 56′, respectively. The plungers 56 and 56′ protrude into fluid filled compartments that are in this embodiment elongated channels 55 extending across the top layer of the touchscreen from one side to the opposite side. Preferably, the fluid is a translucent fluid. The top of the elongated channels 54 is covered by a substantially translucent elastic sheet or foil (cannot be distinguished in the drawing) that bulges out when the pressure inside the elongated channels 55 is increased, and returns to a substantially flat or planar shape when the pressure in the elongated channels is equal to the atmospheric pressure on the other side of the elastic foil or sheet. Translucent bars 58 are disposed between the elongated channels 55. A capacitive touch sensitive layer 61 overlays the LCD display 60 and the translucent bars 58 and the elongated channels 50 are placed on the touch sensitive layer 61. The touch sensitive layer can be disposed between the surface roughness control layer and the LCD screen, or it can be integrated into the roughness control layer depending on the touch sensitive structure (resistive, capacitive or resistive/capacitive sensing).

When the voltage of the parable faulted source 51 is increased the two piezoelectric actuation members 53 and 53′ move in the direction of the arrows 59 and 59′, respectively, thereby urging the plungers 56 and 56′ into the elongated channels 55. Thus, the pressure inside the elongated channels 55 increases and the elastic sheet or flow expands to form the protuberances 54.

According to other embodiments (not shown) the actuation members are not of the piezoelectric type, but are instead electromagnetic, electro or magnetostrictive actuators or the like.

With reference to the screenshot of FIG. 1 an exemplary operation of the touchscreen 3 is explained. A web browser application is active in FIG. 1. The processor 18 has instructed the touchscreen 3 to display a plurality of information items 33,34 on a background. The information items include hyperlinks 33 and control buttons 34.

The software on the mobile phone instructs the processor 18 to associate a low user perceived friction coefficient or surface roughness to the background and a higher user perceived friction coefficient or surface roughness to the information items 33,34. Thus, when the processor 18 receives a signal from the touchscreen 3 that the user is moving an object (stylus or fingertip) over the background, the processor 18 instructs the source of variable voltage 51 to produce substantially zero Volt.

Thus, when an object is moving over positions of the touchscreen 3 where no information item with a higher associated user perceived friction coefficient or surface roughness is displayed, the user perceived friction coefficient or surface roughness of the whole touchscreen 3 is low, since the pressure in the elongated channels 55 will be substantially equal to be atmospheric pressure and the protuberances 58 will be substantially flush with the top surface of the touchscreen 3.

When the processor 18 detects that an object is moving over positions of the touchscreen 3 where information items 33 or 34 are displayed, it will instruct the source of variable voltage 51 to increase the voltage to a level that corresponds to the level of surface roughness associated with the information item 33,34 concerned. The increased voltage will cause the piezoelectric actuation members to urge the plungers 56,56′ into the elongated channels 55 and the resulting increased pressure of the fluid in the elongated channels 55 will cause the elastic foil or sheet to bulge out to form protuberances 54. Thus, when a user moves an object over one of the information items 33,34, he/she will receive an increased surface roughness or friction coefficient and can thereby easier identify/find relevant information items. The area of the touchscreen 3, to which the processor 18 associates an increased user perceived friction coefficient or surface roughness, may correspond exactly to the outline of the information item concerned or, as shown in FIG. 1, the area may correspond to rectangular boxes 33′ and 34′, respectively, that are surrounding the information items concerned (these rectangular boxes are indicated by interrupted lines in FIG. 1).

The change in user perceived surface roughness or friction coefficient is implemented fast enough for the surface roughness or friction coefficient to change whilst the user is moving an object over the surface of the touchscreen 3. For example, whilst the user is moving over an area of the display, where only the background is being displayed, the friction coefficient or surface roughness of the whole touchscreen 3 is low, and at the moment the user moves over a position at which an information item having a higher friction coefficient or surface roughness associated therewith, the surface roughness or friction coefficient of the whole surface of the touchscreen 3 is increased to the associated level, so that the user gets a perception that the information item is covered with a rough surface area whilst the background is covered with a smooth surface area, although physically, the roughness of the surface is always uniformly distributed and dynamically changes in response to user interaction.

Different levels of user perceived surface roughness or friction coefficient may be assigned to different information items or to different groups of information items.

In another embodiment, the fluid filled compartments 58 are be operated with under pressure (pressure below ambient) to cause the elastic sheet to bulge in to thereby increase the surface roughness. In this embodiment (not shown) the pressure is varied between ambient (at which the elastic sheet or foil is flush with the top surface of the touchscreen 3) and pressures below ambient at which a plurality of indentations are formed for increasing surface roughness or friction coefficient.

In order to activate a hyperlink 33 or a command button 34, the processor 18 may be programmed in different ways. One possible activation method is when the user rests on top of the information item concerned for a period longer than a timeout with a predetermined length. Another possibility is a “double click”, i.e. the user will shortly remove the stylus or fingertip from the touchscreen 3 and reapply shortly thereafter the stylus or fingertip to the touchscreen 3 at the same position and activate the hyperlink or the command button concerned. According to another variation, the touchscreen can distinguish between different levels of applied pressure, so that light pressure will be interpreted by the processor 18 as navigational activity and a higher pressure will be interpreted by the processor 18 as an entry command.

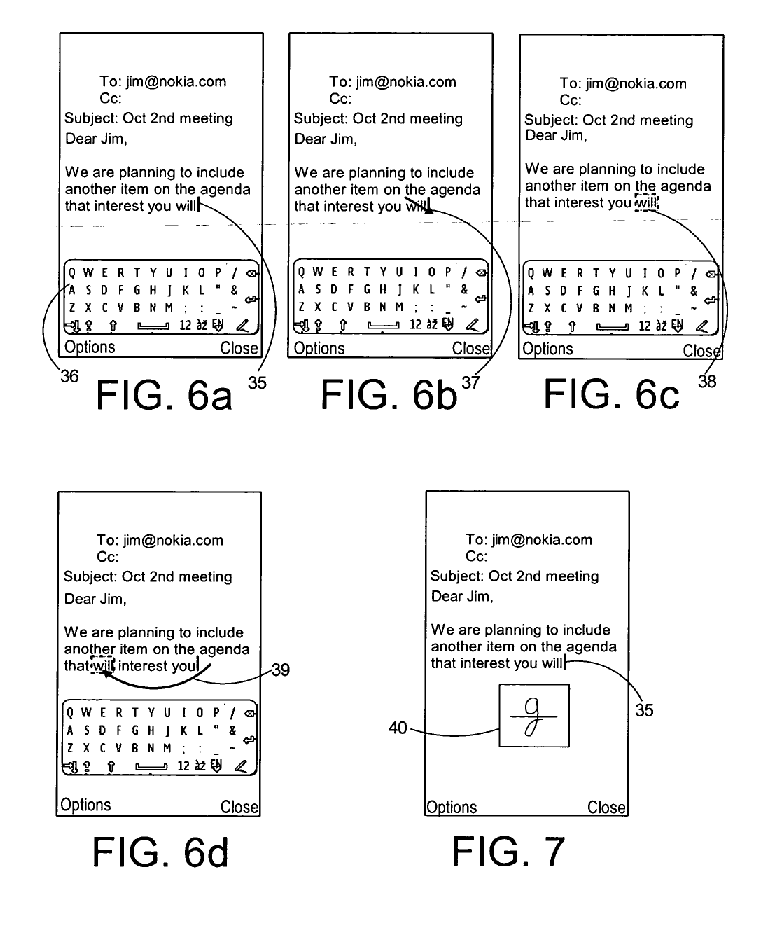

FIGS. 6a to 6d illustrate in four subsequent screenshots the function of dragging and dropping a selected portion of text in a text editing application. In FIG. 6a an e-mail application is active. The user has written a first part of the text. A cursor 35 illustrates the position at which the next character will be entered. The individual characters are entered by pressing on the respective keys of the virtual keypad 36. In FIG. 6a the user has realized that the sequence of the words in the sentence is not correct and by dragging the stylus or fingertip substantially diagonally over the word “will” in the direction of arrow 37 the word “will” gets highlighted by box 38, as shown in FIG. 6c. After the word has been highlighted the processor 18 associates at higher user perceived friction coefficient or surface roughness with the word “will”. Thus, when the user moves his/her stylus or fingertip back to the highlighted word “will” he/she will perceive an increased surface roughness or friction coefficient when moving over this word. Next (FIG. 6d), the user drags the marked the word “will” by a movement of his/her stylus or fingertip along the arrow 39 to insert the marked word “will” at the desired position in the sentence. The processor associates a higher user perceived surface roughness or friction coefficient with the dropping area, so the user notices when the movement along arrow 39 is close to becoming an end.

According to an embodiment the processor may associate an increased user perceived friction or surface roughness with the outline of the virtual keys of the keyboard 36. According to an embodiment a different user perceived friction coefficient or service roughness can be associated to an information item shown on the display depending on the information item being highlighted or not.

FIG. 7 illustrates with one screenshot a handwritten character entry. In FIG. 7 a messaging application is active and displays a handwriting entry box 40 below the already entered text. A cursor 35 illustrates the position at which the next character is entered. The processor 18 associates a higher surface roughness or friction coefficient with the handwriting entry box 40, than with the display area surrounding the handwriting entry box 40. Thus, the area of the handwriting entry box 40 feels rougher than the area outside. If the user goes outside this area, the haptic feeling changes and thus the user will easily notice that he/she is no longer in the text entry area. The same principle of a differentiated surface roughness can be applied to any other type of entry box.

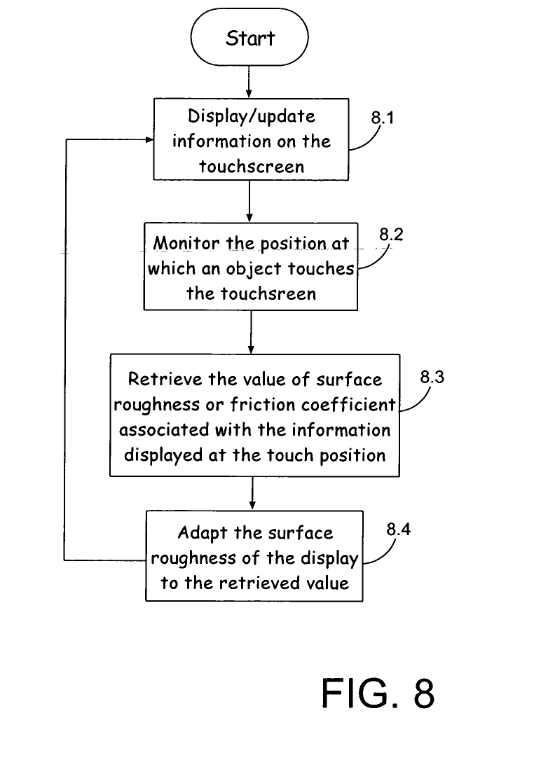

FIG. 8 illustrates an embodiment of the invention by means of a flowchart.

In step 8.1 the processor 18 displays and/or updates information on the touch screen 3 in accordance with the software code of an active program or application.

In step 8.2 the processor monitors the position at which an object touches the touch sensitive surface of the touchscreen 3 via feedback from the touch sensitive surface of the touchscreen.

In step 8.3 the processor 18 retrieves or determines the surface roughness and/or friction coefficient associated with the information displayed at the position where the touch is registered. The retrieval or determination of the value of the surface roughness and/or friction coefficient associated with the information displayed at the point of touch can be performed by retrieval from a table or database (stored in a memory of the device) in which the respective values are stored.

In step 8.4 the processor 18 adapts the surface roughness and/or friction coefficient of the touchscreen to the actual retrieved or determined value. The adaptation of the surface roughness and/or friction coefficient is in an embodiment performed faster than the speed at which a user typically moves an object over the touchscreen during user interaction with the device, so that the adaptation of the surface roughness and/or friction coefficient is dynamic and the user experiences a locally changing surface roughness and/or friction coefficient that is related to the information displayed at the point of touch.

It is noted that the change of user perceived surface roughness or friction coefficient is applied uniformly to the display surface when the processor 18 instructs the user perceived surface roughness or friction coefficient to change. Thus, in any given point in time the user perceived surface roughness or friction coefficient is the same throughout the touchscreen 3.

The methods of operating the touchscreen of the embodiments described above are implemented in a software product (e.g. stored in flash ROM 16). When the software is run on the processor 18 it carries out the method of operation in the above described ways.

The embodiments described above apply the dynamically controlled variable user perceived surface roughness or friction coefficient to the entire surface of the touchscreen 3. According to an embodiment (not shown) the variably controlled surface roughness can be applied to a particular portion of the touchscreen 3 only, e.g. only the top half or only a central square, etc.

The invention has numerous advantages. Different embodiments or implementations may yield one or more of the following advantages. It should be noted that this is not an exhaustive list and there may be other advantages which are not described herein. One advantage of the invention is that a user will easily recognize when he/she moves out of a particular area on the display that is associated with information displayed on the touchscreen 3. Another advantage is that the user receives haptic feedback while moving over the display which increases user confidence and acceptance of the technology. Another advantage is that changing the friction can assist the user with movement to target areas, like dragging the object to destinations i.e. folders, trash bins etc. For example friction decreases when closing in on allowed target areas and thus the target area virtually pulls the object in the right direction. Another advantage is that friction can illustrate the virtual “mass” of the dragged object, i.e. a folder containing a larger data amount feels more difficult to drag to trash bin compared to a “smaller” folder containing less data by having larger friction during dragging.

The term “comprising” as used in the claims does not exclude other elements or steps. The term “a” or “an” as used in the claims does not exclude a plurality. The single processor or other unit may fulfill the functions of several means recited in the claims.

The reference signs used in the claims shall not be construed as limiting the scope.

Although the present invention has been described in detail for purpose of illustration, it is understood that such detail is solely for that purpose, and variations can be made therein by those skilled in the art without departing from the scope of the invention. For example, the fluid filled compartments can be operated with under pressure (pressure below ambient) to cause the elastic sheet to bulge in to thereby increase the surface roughness.

1. A touchscreen comprising a display comprising:
a touch sensitive screen surface,
at least a portion of said touch sensitive screen surface having at least one of user perceived surface roughness and friction coefficient, wherein said at least one of user perceived surface roughness and friction coefficient is variable and controllable.

2-31. (canceled)

32. A touchscreen according to claim 1, wherein said at least one of user perceived surface roughness and friction coefficient is at least one of the following:
dynamically varied;
dynamically varied whilst an object is moving over the touch sensitive screen surface; and
uniform for the whole of said portion of said touch sensitive screen.

33. A touchscreen according to claim 1, wherein a speed of change of said at least one of user perceived surface roughness and friction coefficient is faster than the user interaction, so that at least one of a roughness and a friction pattern can be created in tact with the user interaction.

34. A touchscreen according to claim 1, wherein information is displayed on said display in the portion having said at least one of user perceived surface roughness and friction coefficient, and wherein said at least one of user perceived surface roughness and friction coefficient of said portion is controlled in dependence on the information displayed at the position at which an object touches the touch screen.

35. A touchscreen according to claim 34, wherein said information is displayed as information items on a background, and wherein a level of said at least one of perceived surface roughness and friction coefficient associated with the background is different from a level of said at least one of perceived surface roughness and friction coefficient associated with the information items.

36. A touchscreen according to claim 35, wherein the level of said at least one of perceived surface roughness and friction coefficient associated with an information item is applied when an object touches the display in an area of the touch sensitive surface that substantially corresponds to the outline of the displayed information item.

37. A touchscreen according to claim 1, wherein said portion of said touch sensitive screen surface is provided with at least one of the following:
plurality of controllable protuberances;
plurality of controllable indentations;
plurality of controllable protuberances, wherein the protuberances are simultaneously controlled between a substantially flat position and an extended position;
plurality of controllable indentations, wherein the indentations are simultaneously controlled between a retracted position and a substantially flat position.

38. A touchscreen according to claim 37, wherein said at least one of the user perceived roughness and friction coefficient of said portion is controllable by varying the position of said protuberances and/or said indentations.

39. A touchscreen according to claim 37, wherein the protuberances are simultaneously controlled between a plurality of intermediate positions in between said substantially flat position and said extended position.

40. A touchscreen according to claim 37, wherein the indentations are simultaneously controlled between a plurality of intermediate positions in between said substantially flat position and said retracted position.

41. A touchscreen according to claim 37, wherein at least one of said protuberances and said indentations are part of fluid filled compartments disposed in said touch sensitive screen display.

42. A touchscreen according to claim 41, wherein said fluid filled compartments are operably connected to a controllable source of pressure.

43. A touchscreen according to claim 41, wherein said protuberances are formed by an elastic sheet bulging out under high pressure of the fluid in the compartments.

44. A touchscreen according to claim 41, wherein said indentations are formed by said elastic sheet bulging in under the pressure difference between the atmosphere and low pressure of the fluid in the compartments.

45. A touchscreen according to claim 37, wherein said protuberances are elongated elements that extend in parallel across said portion of the touchscreen.

46. An electronic device comprising:
a processor,
a touch sensitive screen with a touch sensitive screen surface, at least a portion of said touch sensitive screen surface having at least one of user perceived surface roughness and friction coefficient, wherein said at least one of user perceived surface roughness and friction coefficient is variable and controllable
said touchscreen being coupled to said processor, and
said at least one of user perceived surface roughness and friction coefficient being controlled by said processor.

47. An electronic device according to claim 46, wherein said processor controls said at least one of user perceived surface roughness and friction coefficient in response to user input on said touchscreen.

48. An electronic device according to claim 46, wherein said processor controls said at least one of user perceived surface roughness and friction coefficient in relation to the information displayed at the position at which an object touches the touch sensitive screen surface.

49. A method of operating a touchscreen of an electronic device, said touchscreen being provided with touch sensitive surface and at least a portion of said touch sensitive surface having at least one of user perceived roughness and friction coefficient, comprising:
displaying information on said touchscreen, and
dynamically controlling said at least one of user perceived surface roughness and friction coefficient of the whole of said portion in relation to the information displayed at the position where an object touches said touch sensitive surface.

50. A software product for use in a mobile electronic device that is provided with a touchscreen with a variable and controllable at least one of user perceived surface roughness and friction coefficient, said software product comprising:
software code for displaying information on said touchscreen, and
software code for dynamically controlling said at least one user perceived surface roughness and friction coefficient of the whole of said portion in relation to the information displayed at the position where an object touches said touch sensitive surface.
